(19) United States
(12) Patent Application Publication
(10) Pub. No.: US 2009/0101809 A1
(43) Pub. Date: Apr. 23, 2009

(54) MASS SPECTROMETRY-BASED QUANTITATIVE ASSAY FOR DETERMINING ABUNDANCE OF MOLECULAR SPECIES IN A COMPOSITION

(75) Inventor: Sibylle M. Wilbert, Seattle, WA (US)

Correspondence Address: DAVID S. RESNICK, NIXON PEABODY LLP, 100 SUMMER STREET, BOSTON, MA, 02110-2131, US

(73) Assignee: ZYMOGENETICS, INC., Seattle, WA (US)

(21) Appl. No.: 12/204,869

(22) Filed: Sep. 5, 2008

Related U.S. Application Data
(60) Provisional application No. 60/970,190, filed on Sep. 5, 2007.

(51) Int. Cl. H01J 49/00

(52) U.S. Cl. 250/281

(57) ABSTRACT

Provided herein are quantitative LC-MS methods is aimed at identifying and quantifying the molecular species in a composition. Additionally provided are compositions comprising one or more molecular species.

### CROSS-REFERENCE TO RELATED APPLICATIONS

This application claims benefit of U.S. Provisional Patent Application Ser. No. 60/970,190, filed Sep. 5, 2007, which is hereby incorporated by reference in its entirety.

### TECHNICAL FIELD

Mass spectrometry methods for determining the relative abundance of molecular species in composition suspected of comprising more than one molecular species.

### BACKGROUND

The human α-thrombin dipeptide is composed of an A-chain and a B-chain linked to each other by one inter-chain disulfide bond, as shown schematically in FIG. 1. The B-chain has one N-linked glycosylation site, which is typically occupied by a variety of mainly biantennary oligosaccharides. α-Thrombin has autocatalytic activities, which leads to the presence of small amounts of α-thrombin autolysis products in thrombin products, including recombinantly produced thrombin (rThrombin) products. In contrast to the full-length protein, the autolysis products are not expected to show blood clotting activity. It is therefore necessary to control their abundance in the final product.

Liquid chromatography coupled with mass spectrometry (LC-MS) methods are useful for identifying the presence of a plurality of species in a composition. LC-MS will identify the various molecular species in a purified thrombin product, including autolysis products. Unfortunately, LC-MS methods will not provide a quantitative determination of the amount of any of the molecular species in a composition. This is problematic for a variety of reasons, including quantifying the abundance of an active molecular species in a composition and maintaining lot to lot consistency of active molecular species.

There is a need in the art for a quantitative method for determining the presence and amount of molecular species in a composition. There is also a need in the art to identify and control the abundance of one or more molecular species in a composition.

### SUMMARY

Provided herein are quantitative LC-MS methods aimed at identifying and quantifying the molecular species in a composition. Additionally provided are compositions comprising one or more molecular species.

In one embodiment there is provided a method for determining batch purity of a thrombin composition, comprising the steps of: obtaining a batch of thrombin composition, wherein said thrombin composition comprises an α-thrombin molecule and autolysis products of said α-thrombin molecule; providing from about 0.5 μg to about 2.5 μg of said thrombin composition to an HPLC compatible solvent to obtain a solution of from about 0.2 mg/ml to about 0.5 mg/ml of said recombinant thrombin in solvent; providing said solution to a gradient column and collecting fractions of solution; providing said fractions to a mass spectrometer; detecting a molecular mass of the fractions; and quantifying the relative amount of α-thrombin molecule and relative amount of said autolysis products as a percentage of total recombinant thrombin composition. Preferably, said thrombin composition is recombinant α-thrombin, and more preferably recombinant human α-thrombin.

Thus, in a further aspect of this embodiment there is provided a thrombin composition comprising α-thrombin molecules further comprising an A-chain and a B-chain linked together by an inter-chain disulfide bond; and autolysis products from said α-thrombin molecule, said autolysis products comprising an AutA species, an AutB species, an AutB′ species, an AutC species and an AutD species, wherein said α-thrombin molecule is from about 90.0% to about 93.0% and wherein said autolysis products are from about 7.0% to about 10.0% as determined by LC-MS. Preferably, said thrombin composition is recombinant α-thrombin, and more preferably recombinant human α-thrombin.

In another embodiment there is provided a method for determining lot-to-lot consistency of a thrombin composition, comprising the steps of: obtaining a thrombin compositions, wherein said thrombin composition comprises α-thrombin molecules and autolysis products of said α-thrombin molecules; generating a solution of thrombin composition in an HPLC compatible solvent wherein said solution: (i.) is from about 0.2 mg/ml to about 0.5 mg/ml of said thrombin composition in HPLC compatible solvent; and (ii.) totals from about 0.5 μg to about 2.5 μg of said thrombin composition; providing said solution to a gradient column and collecting a set of fractions for said solution; providing said fractions to a mass spectrometer to generate a molecular mass profile; detecting a molecular mass of the fractions, thereby generating a molecular mass profile for said solution; quantifying the relative amount of α-thrombin molecules and relative amount of said autolysis products as a percentage of total thrombin composition for said thrombin composition; and comparing said quantified amount of α-thrombin molecules and/or said quantified amount of said autolysis products to a reference thereby determining lot-to-lot consistency for said thrombin composition. Preferably, said thrombin composition is recombinant α-thrombin, and more preferably recombinant human α-thrombin.

One aspect of the present invention is directed toward a method for determining batch purity of a thrombin composition. The method includes the steps of obtaining a batch of thrombin composition comprising α-thrombin molecule and autolysis products of said α-thrombin molecule. A sample of the thrombin composition is provided to a chromatographic compatible solvent to obtain a solution of the thrombin in solvent. The solution is provided to a gradient column and fractions of solution collected. The fractions are provided to a mass spectrometer. The molecular mass of the fractions is detected. And the relative amount of α-thrombin molecule and relative amount of said autolysis products are quantified as a percentage of total thrombin composition.

Another aspect of the present invention is directed toward a method for determining lot-to-lot consistency of a thrombin composition. The method includes the steps of obtaining a thrombin composition, wherein said thrombin composition comprises α-thrombin molecules and autolysis products of said α-thrombin molecules. A solution of thrombin composition in an HPLC compatible solvent is generated wherein the solution is from about 0.2 mg/ml to about 0.5 mg/ml of said thrombin composition in HPLC compatible solvent, and totals from about 0.5 μg to about 2.5 μg of said thrombin composition. The solution generated is provided to a gradient column and a set of fractions for the solution is collected. The fractions are provided to a mass spectrometer to generate a molecular mass profile. Molecular mass of the fractions is detected thereby generating a molecular mass profile for the solution. The relative amount of α-thrombin molecules and relative amount of said autolysis products as a percentage of total thrombin composition for said thrombin composition is quantified. The quantified amount of α-thrombin molecules and/or said quantified amount of said autolysis products is compared to a reference thereby determining lot-to-lot consistency for said thrombin composition.

### BRIEF DESCRIPTION OF THE FIGURES

FIG. 1 is a schematic illustration of alpha thrombin.

FIG. 2 is a schematic illustration of some alpha.thrombin autolysis products identified and quantified by the current methods.

FIG. 3 shows a typical UV and TIC chromatograms of a degraded rThrombin bulk drug substance (BDS) sample with peak assignments.

FIG. 4. Method for Identification and Quantitation of α-thrombin Variants from Peak Region 3. The four panels show the total ion current (TIC) of a degraded rThrombin sample, mass spectrometric data from the selected peak region 3 (shaded in blue, B), deconvoluted masses from the selected peak region detected within 8,000-40,000 Da (C), and a list of the deconvoluted masses seen in panel C including their respective area counts (D). The mass list is further processed in a Microsoft Excel spreadsheet to derive qualitative and quantitative results.

FIG. 5. Comparison of Deconvolution Methods. The top panel shows the deconvoluted data for a degraded rThrombin sample generated from the TIC range spanning all three peak regions (5.2-16.0 minutes). The following three panels show the intact mass data from the same sample deconvoluted three times after selecting each peak region separately. The uppermost of these three following panels (panel 2) shows peak region 3 (main peak, 11.8-16.0 minutes), the following panel (panel 3) peak region 2 (8.0-11.8 minutes), and the last panel (panel 4) peak region 1 (5.2-5.8 minutes). Each deconvolution was performed within 8,000-40,000 Da using the same settings. Circled peaks are deconvolution artifacts.

FIG. 6. Illustrates Selection of Peak Regions 1-3 for Intact Mass Analysis.

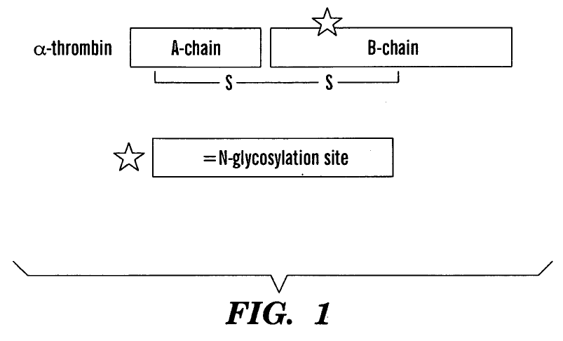

### DESCRIPTION

### Abbreviations

### ACN Acetonitrile

### BDS Bulk Drug Substance

### DAD Diode Array Detector

LC-MS Liquid Chromatography Coupled with Mass Spectrometry

### m/z Mass (m) of Analyte Divided by Its Charge (z)

### N Number of Determinations

### P/N Part Number

### RP-HPLC Reversed Phase High Pressure Liquid Chromatography

### % RSD Percent Relative Standard Deviation

### SDB Sample Dilution Buffer

### STDEV Standard Deviation

### TIC Total Ion Current

### TFA Trifluoroacetic Acid

### TOF Time-of-Flight

### TWC Total Wavelength Chromatogram

rhthrombin Recombinant Human thrombin

### XWC Extracted Wavelength Chromatogram

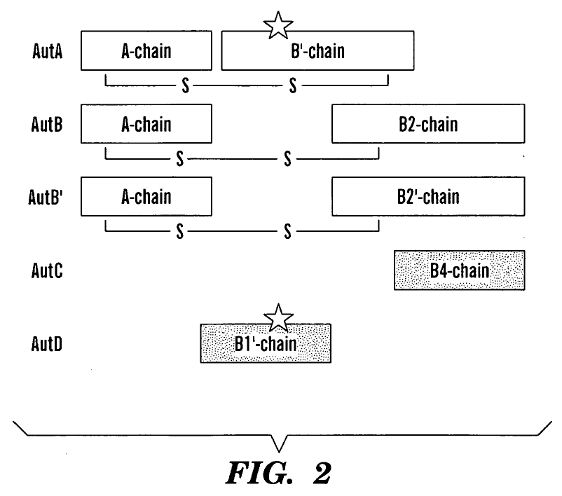

The described LC-MS method is aimed at identifying and quantifying the molecular species in a composition. Preferably, the composition comprises α-thrombin, more preferably recombinant α-thrombin and most preferably recombinant human α-thrombin. Additionally, said composition may comprise α-thrombin autolysis products. (FIG. 2) The composition is preferably an enzyme composition, more preferably a pharmaceutical composition and most preferably a bulk drug substance (BDS). Following separation of α-thrombin from its autolysis products by reversed phase chromatography, analysis of each peak region detected in the chromatogram by mass spectrometry, preferably Time-of-Flight (TOF) mass spectrometry, provides qualitative and quantitative information for each variant and demonstrates the absence of new variants not detected in the thrombin Reference Standard. The method provides complementary information to the analytical RP-HPLC method used for purity determinations. It can be used to determine lot-to-lot consistency, thereby, demonstrating control of the manufacturing process. In addition, the method is stability-indicating and may be used as such.

Bulk drug samples comprising recombinant human α-thrombin were obtained from a frozen, ≦−60° C., stock of recombinantly produced human thrombin. Triplicate aliquots of stock were allow to thaw at ambient temperature and then were gently mixed to ensure a uniform solution. Stock samples were prepared as three separate samples by transferring the appropriate amount of test sample into three Eppendorf tubes and diluting each with SDB to achieve 50 μL of a 0.5 mg/mL solution. The diluted stock test samples were gently mixed and transferred into three HPLC vials with glass inserts. For test sample having a concentration between 0.2-0.5 mg/mL, 3×50 μL was transferred directly into three HPLC vials with glass inserts. Test samples at a concentration of <0.2 mg/mL were concentrated to 0.5 mg/mL prior to analysis. The HPLC vials containing test samples were then placed into a chilled HPLC auto-sampler maintained at 4° C. Those ordinarily skilled in the art will readily generate composition samples for use with the disclosed methods. Such samples may include, but are not limited to samples comprising thrombin. (See e.g., U.S. Pat. Nos. 5,476,777; and 5,527,692).

Intact mass analysis was performed by liquid chromatography coupled with mass spectrometry (LC-MS) using an Agilent Capillary HP1100 HPLC interfaced with an Agilent LC/MSD time-of-flight (TOF) mass spectrometer (Agilent Technologies, Inc. Santa Clara, Calif.). Following external calibration of the mass spectrometer, samples were injected on a PLRP-S column (1.0×50 mm, 300 Angstrom, 5 μm) and chromatographed with a water/acetonitrile/0.1% TFA (w/v) gradient, which was optimized to mimic the resolution of an analytical RP-HPLC method used for main peak purity determination. Samples were prepared at a concentration of 0.3 mg/mL by dilution with HPLC-grade water and injected onto the column at a load of 1.5 μg. The HPLC outlet flow was directed into the mass spectrometer together with a continuous infusion of three reference ions for internal mass calibration. Test samples were analyzed in triplicate, and the system suitability standard was analyzed twice in triplicate bracketing the test samples.

MS data were acquired, averaged for each resolved chromatographic peak, and deconvoluted within an m/z range of 930 to 2785 and a mass range of 8,000-40,000 Da using the Agilent TOF Protein Confirmation software (A.02.00). The detected masses were matched with the calculated masses of α-thrombin and its autolysis products for identification. The glycosylated variants α-thrombin, AutA, and AutD were each identified by matching the three most abundant masses with the calculated masses of their glycoforms. For quantitative analysis, the area counts of the deconvoluted masses were summed within the mass ranges specific to each variant including their glycoforms if present. The amount of each variant was calculated from its total area counts as a percentage of the sum of the area counts of all variants. Final results were reported as an average from triplicate analyses (See below).

The LC-TOF assay complements the RP-HPLC assay for purity determination of recombinant human thrombin and was developed to identify and quantify the glycoprotein α-thrombin and its autolysis products, and to establish that the same variants are consistently present in commercial lots of BDS. The method was successfully used for lot-to-lot comparison and release testing of rThrombin. Different lots of BDS, which is manufactured under well-controlled conditions, are consistent in composition and typically vary by no more than three percentage points in main peak purity. Therefore, these samples are well-suited for quantitative mass spectrometric analysis by the described approach. Although the accuracy of the quantitative determinations by this method requires further validation, the assay has proved sufficiently reproducible and precise. The quantitative results were in good agreement with RP-HPLC purity data.

This herein described assay is useful for quantitatively identifying a plurality of molecular species in a composition. Though illustrated herein with a recombinant human thrombin BDS, those ordinarily skilled in the art will readily apply the described methods to a variety of composition for quantitative determination of molecular species comprising said composition.

Another aspect of the present invention is directed toward a method for determining batch purity of a thrombin composition. The method includes the steps of obtaining a batch of thrombin composition comprising α-thrombin molecule and autolysis products of said α-thrombin molecule. A sample of the thrombin composition is provided to a chromatographic compatible solvent to obtain a solution of the thrombin in solvent. The solution is provided to a gradient column and fractions of solution collected. The fractions are provided to a mass spectrometer. The molecular mass of the fractions is detected. And the relative amount of α-thrombin molecule and relative amount of said autolysis products are quantified as a percentage of total thrombin composition.

In a preferred embodiment, the thrombin is recombinant thrombin. In certain embodiments, the thrombin is plasma-derived thrombin. Suitable plasma-derived thrombins include human plasma-derived thrombin or bovine plasma-derived thrombin.

In certain embodiments, the recombinant thrombin composition comprises a recombinant α-thrombin molecule and autolysis products of said recombinant α-thrombin molecule. In certain embodiments, the sample is from about 0.5 μg to about 2.5 μg of the recombinant thrombin composition. In certain embodiments, the chromatographic compatible solvent is an HPLC compatible solvent, preferably HPLC grade water. In certain embodiments, the solution is a solution of from about 0.2 mg/ml to about 0.5 mg/ml of the recombinant thrombin in the solvent.

In certain embodiments, autolysis products comprise an AutA species, an AutB species, an AutB′ species, an AutC species and an AutD species.

In a preferred embodiment, the chromatographic compatible solvent is HPLC grade water and gradient column is a PLRP-S column. Also in a preferred embodiment, the gradient column is in contact with the mass spectrometer such that said fractions of the solution will elute into the mass spectrometer.

In certain embodiments, the mass spectrometer is an ESI-TOF mass spectrometer or a MALDI-TOF mass spectrometer.

In certain embodiments, one or more reference ions are added to one or more of the fractions, thereby providing an internal mass calibrant.

In certain embodiments, at the step of detecting a molecular mass said molecular mass is detected with a mass to charge ratio of from about 900 to about 3250. In certain embodiments, at the step of detecting a molecular mass said molecular mass is detected with a mass range from about 7,000 Da to about 50000 Da.

In a preferred embodiment, the recombinant α-thrombin molecule is quantified to make up from about 90.0% to about 93.0% of said recombinant thrombin composition. In a preferred embodiment, the autolysis product is quantified to make up from about 7.0% to about 10.0% of said recombinant thrombin product.

In certain embodiments, the AutA species is from about 1.8% to about 3.0% as determined by LC-MS. In certain embodiments, the AutB species is from about 3.5% to about 5.3% as determined by LC-MS. In certain embodiments, the AutB′ species is from about 0.25% to about 0.75% as determined by LC-MS. In certain embodiments, the AutC species is from about 0.5% to about 1.1% as determined by LC-MS. In certain embodiments, the AutD species is from about 0.2% to about 0.65% as determined by LC-MS.

In a preferred embodiment, the quantified amount of recombinant α-thrombin is compared to a standard acceptable range for quantity of recombinant α-thrombin in a batch. In a preferred embodiment, the quantified amount of said autolysis product is compared to a standard acceptable range for quantity of autolysis product in a batch. In certain embodiments, one or more of said autolysis product species is compared to a standard acceptable range for quantity of said one or more autolysis product species in a batch.

Yet another aspect of the present invention is directed toward a method for determining lot-to-lot consistency of a thrombin composition. The method includes the steps of obtaining a thrombin composition, wherein said thrombin composition comprises α-thrombin molecules and autolysis products of said α-thrombin molecules. A solution of thrombin composition in an HPLC compatible solvent is generated wherein the solution is from about 0.2 mg/ml to about 0.5 mg/ml of said thrombin composition in HPLC compatible solvent, and totals from about 0.5 μg to about 2.5 μg of said thrombin composition. The solution generated is provided to a gradient column and a set of fractions for the solution is collected. The fractions are provided to a mass spectrometer to generate a molecular mass profile. Molecular mass of the fractions is detected thereby generating a molecular mass profile for the solution. The relative amount of α-thrombin molecules and relative amount of said autolysis products as a percentage of total thrombin composition for said thrombin composition is quantified. The quantified amount of α-thrombin molecules and/or said quantified amount of said autolysis products is compared to a reference thereby determining lot-to-lot consistency for said thrombin composition.

In a preferred embodiment, the thrombin is recombinant thrombin. In certain embodiments, the thrombin is plasma-derived thrombin. Suitable plasma-derived thrombins include human plasma-derived thrombin or bovine plasma-derived thrombin. In certain embodiments, the recombinant thrombin composition comprises a recombinant α-thrombin molecule and autolysis products of said recombinant α-thrombin molecule. In certain embodiments, the sample is from about 0.5 μg to about 2.5 μg of the recombinant thrombin composition. In certain embodiments, the chromatographic compatible solvent is an HPLC compatible solvent, preferably HPLC grade water. In certain embodiments, the solution is a solution of from about 0.2 mg/ml to about 0.5 mg/ml of the recombinant thrombin in the solvent.

In certain embodiments, autolysis products comprise an AutA species, an AutB species, an AutB′ species, an AutC species and an AutD species.

In a preferred embodiment, the chromatographic compatible solvent is HPLC grade water and gradient column is a PLRP-S column. Also in a preferred embodiment, the gradient column is in contact with the mass spectrometer such that said fractions of the solution will elute into the mass spectrometer. In certain embodiments, the mass spectrometer is an ESI-TOF mass spectrometer or a MALDI-TOF mass spectrometer.

In certain embodiments, one or more reference ions are added to one or more of the fractions, thereby providing an internal mass calibrant.

In certain embodiments, at the step of detecting a molecular mass said molecular mass is detected with a mass to charge ratio of from about 900 to about 3250. In certain embodiments, at the step of detecting a molecular mass said molecular mass is detected with a mass range from about 7,000 Da to about 50000 Da.

In a preferred embodiment, the recombinant α-thrombin molecule is quantified to make up from about 90.0% to about 93.0% of said recombinant thrombin composition. In a preferred embodiment, the autolysis product is quantified to make up from about 7.0% to about 10.0% of said recombinant thrombin product.

In certain embodiments, the AutA species is from about 1.8% to about 3.0% as determined by LC-MS. In certain embodiments, the AutB species is from about 3.5% to about 5.3% as determined by LC-MS. In certain embodiments, the AutB′ species is from about 0.25% to about 0.75% as determined by LC-MS. In certain embodiments, the AutC species is from about 0.5% to about 1.1% as determined by LC-MS. In certain embodiments, the AutD species is from about 0.2% to about 0.65% as determined by LC-MS.

In certain embodiments, the reference is a second batch of thrombin composition. In certain embodiments, the a plurality of batches of thrombin compositions are separately quantified and the quantification results for each of said plurality of batches serves as a reference for comparison of one to another thereby determining lot-to-lot consistency between said plurality of batches. In certain embodiments, the reference is an external standard.

The present invention also relates to composition of matter consisting essentially of recombinant α-thrombin molecule further comprising an A-chain and a B-chain linked together by an inter-chain disulfide bond; and autolysis products from said recombinant α-thrombin molecule, said autolysis products comprising an AutA species, an AutB species, an AutB′ species, an AutC species and an AutD species, wherein said recombinant α-thrombin molecule is from about 90.0% to about 93.0% and wherein said autolysis products are from about 7.0% to about 10.0% as determined by LC-MS.

In certain embodiments, said AutA species is from about 1.8% to about 3.0% as determined by LC-MS. In certain embodiments, said AutB species is from about 3.5% to about 5.3% as determined by LC-MS. In certain embodiments, said AutB′ species is from about 0.25% to about 0.75% as determined by LC-MS. In certain embodiments, said AutC species is from about 0.5% to about 1.1% as determined by LC-MS. In certain embodiments, said AutD species is from about 0.2% to about 0.65% as determined by LC-MS.

In certain embodiments, said composition is packaged as a powder in a vial. The vial may contain from about 5000 IU to about 20000 IU of recombinant α-thrombin molecule. In certain embodiments, the vial may contain from about 5000 IU to about 20000 IU of said composition. In certain embodiments, said vial is a vial selected from the group consisting of colored glass, clear glass and a syringe.

Further illustration of the method is provided by the following non-limiting examples.

### EXAMPLES

Following LC-TOF analysis, levels of each detected variant were derived from area counts of their deconvoluted masses. However, a number of method-specific limitations were taken into consideration: (i) sialylated glycoproteins may show a lower abundance than the same species missing the sialic acid moiety because acidic residues do not ionize as readily in positive ionization mode as neutral and basic molecules; (ii) in a mixture of co-eluting species the abundance of some of the components can become skewed because of competition for charge in the ESI source or masking of low-level ions by more abundant ones; (iii) by ESI-MS, the linear range for any given analyte can be particularly restricted because the response at increasing concentrations tends to plateau; and (iv) the range of differences in total ion current (TIC) peak width and height has to be narrow from lot to lot because the quantitative results are derived from averaged deconvoluted spectral data. Therefore, in recognition of these caveats, a method was developed that allowed for sufficiently reproducible quantitative determinations of the low-level autolysis products in the presence of the main peak.

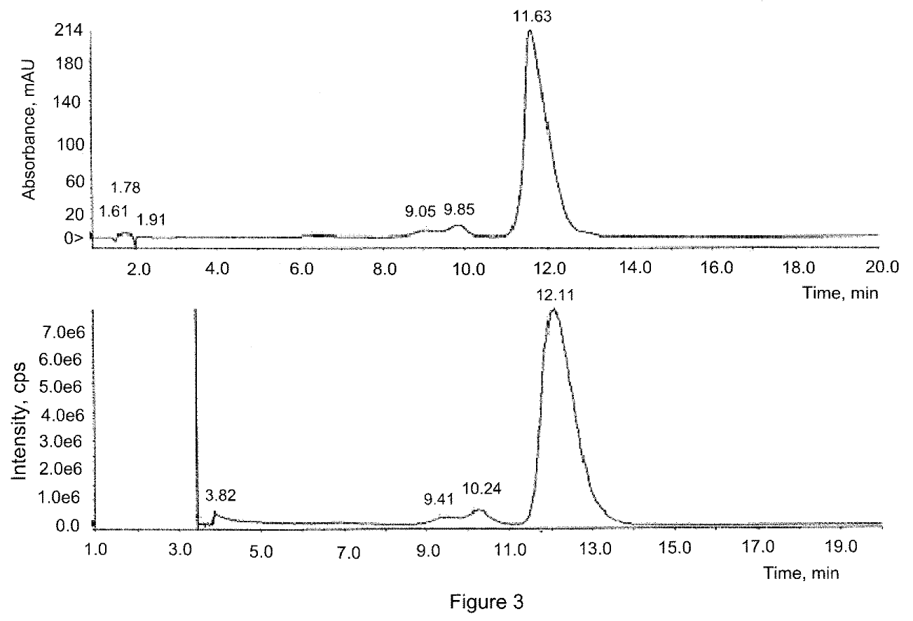

Optimization of LC and MS method parameters. Chromatographic, mass spectrometric, and data processing parameters were tested and refined using freshly-thawed or force-degraded rThrombin samples. First, the chromatographic parameters of the method were established by scaling a previously developed analytical RP-HPLC method to a capillary LC system. A resolution profile comparable to the analytical method was achieved by modifying the column dimensions, flow rate, and elution gradient. (See Table 3). Columns containing rigid, macroporous spherical particles of polystyrene and divinylbenzene copolymer are preferably used. (E.g., PLRP-S columns, Phenomix, Inc, Torrance, Calif.) The copolymer of these columns is chemically and physically stable across the complete pH range and the resin is rated to up to 200° C. Thus, maximum temperature settings were set based on physical properties of the mobile phase, and not limitations of the column resin. Method development data has further shown lot to lot variances in retention time do not affect overall quantitative analysis. Several column lots were tested to assess consistency of the chromatographic profiles. FIG. 3 shows typical chromatograms from a degraded sample. The MS method was optimized for maximum signal intensity of each variant without inducing fragmentation by tuning the ESI source parameters including capillary voltage, fragmentor voltage, octapole RF voltage, skimmer voltage, drying gas flow, gas temperature, and nebulizer pressure. (See Table 4).

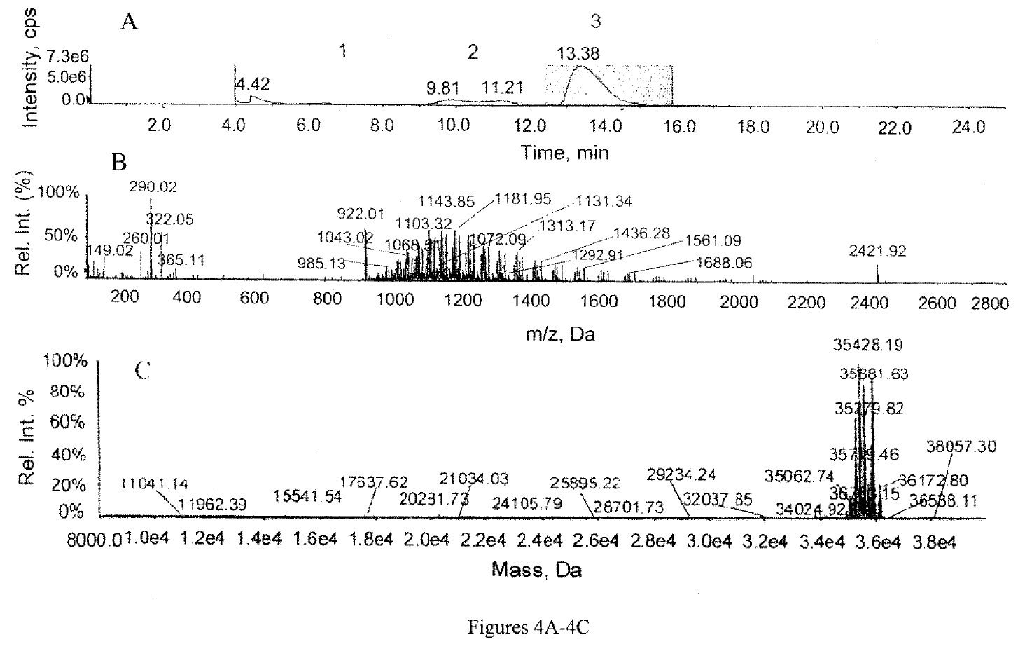

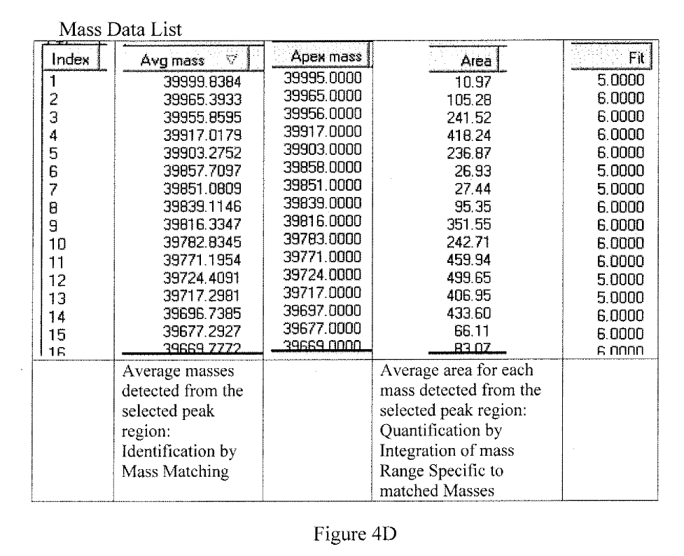

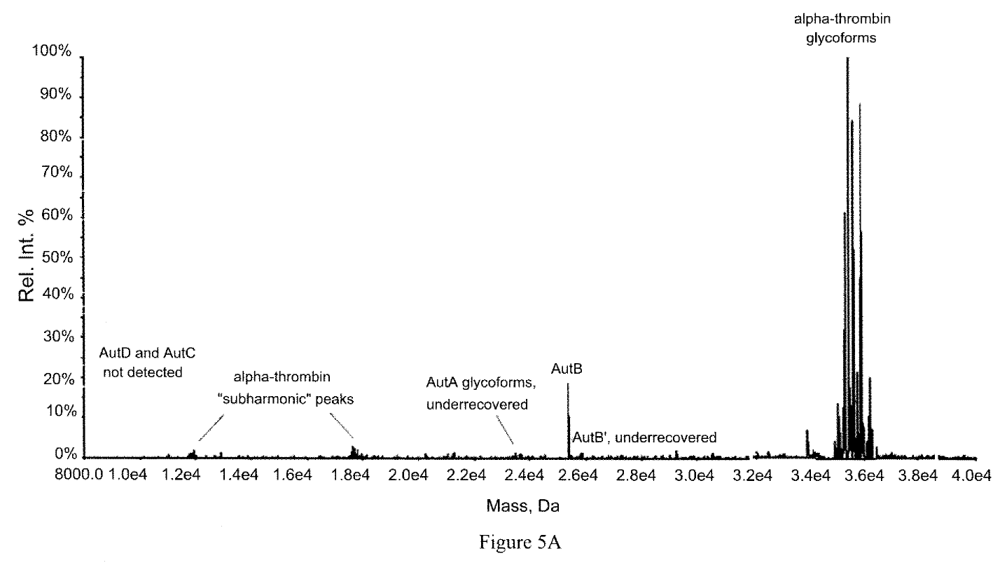

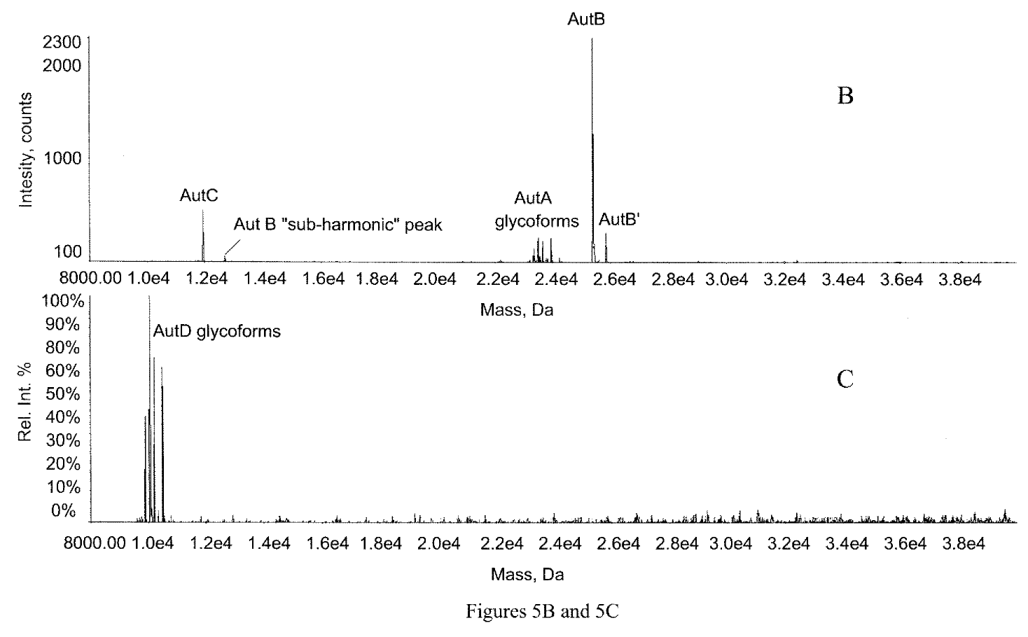

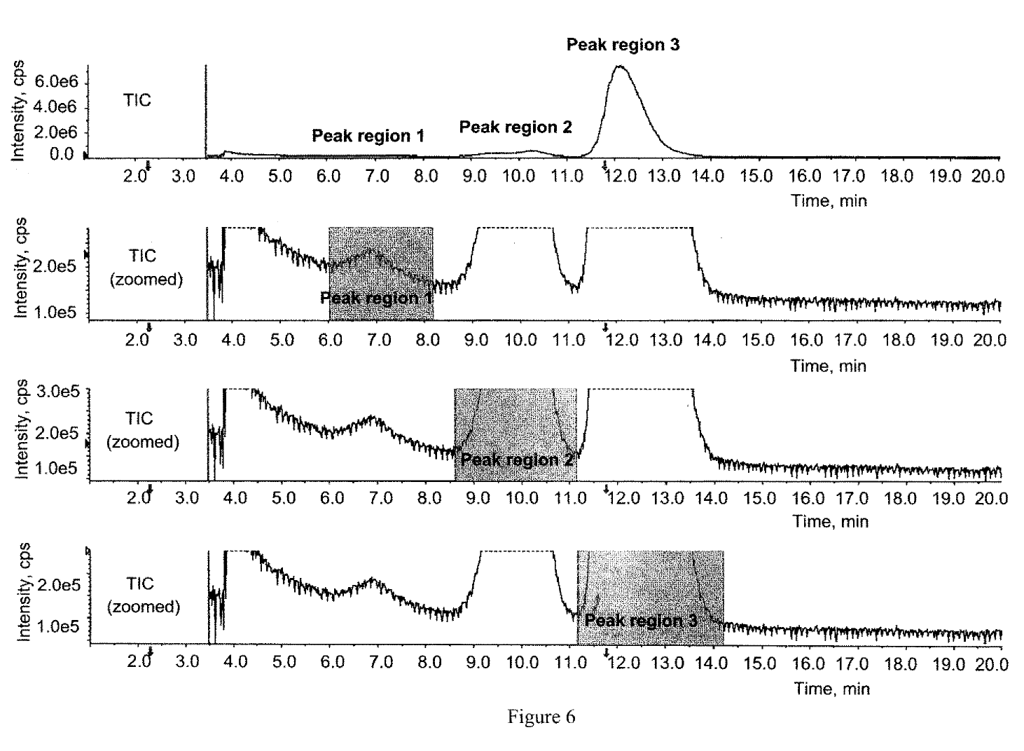

As exemplified in FIG. 4, qualitative and quantitative analyses were performed by displaying the deconvoluted mass list, transferring the data into spreadsheets (e.g. Microsoft® Office Excel®), and processing the masses and corresponding area counts within the mass ranges specific to each variant. Qualitative results were assessed by monitoring intra- and inter-assay accuracy of matched masses. The precision and accuracy of the qualitative results proved robust, because both external and internal calibration procedures were part of the method. Quantitative results were assessed by testing processing options for raw and deconvoluted data using the RP-HPLC main peak purity results of the test samples for guidance. Specifically, variables including deconvolution settings, sample load, peak selection, mass ranges for summing area counts, and background subtraction were investigated. As shown in FIG. 5, it was found that processing the raw data from the entire chromatographic range in one step did not yield representative results. Instead, it was necessary to divide the TIC into three peak regions; peak region 1 containing AutD, peak region 2 containing AutA, AutB, AutB′, and AutC, and peak region 3 containing α-thrombin. Using defined TIC peak selection criteria (valley-to-valley, FIG. 6); the three peak regions were processed independently without background subtraction using the same deconvolution settings. This approach showed good precision within a working range of 1.0-2.0 μg of sample load for BDS samples.

Assay qualification. Data collected from inter- and intra-assay variability studies performed during method development were used to qualify the method and determine acceptance criteria for mass accuracy, accuracy of targeted test sample load, % peak area determinations for each variant, intra- and inter-assay reproducibility of the measurements, and column performance. Acceptance criteria for a release assay for purity determination of rThrombin BDS were also derived. Tables 1 and 2 show the results from a degraded rThrombin samples as an example. Identification of the detected variants by mass matching showed good accuracy (Table 1) and relative amounts of each variant were determined with good reproducibility (Table 2). The results were consistent with the main purity of the sample determined by RP-HPLC (Table 2).

All references and patents cited herein are hereby incorporated by reference in their entirety.

TABLE 1
Qualitative Intra-Assay Accuracy Qualitative Intra-Assay
Accuracy: Average Deviation of Main Detected Masses from
Calculated Masses for α-thrombin and its Autolysis Products
in a Degraded rThrombin Sample (N = 6)

| | Average Deviation from | Standard |
|---|---|---|
| Identification | Calculated Mass [ppm] | Deviation |
| α-thrombin (glycoform A) | 5.5 | 0.83 |
| α-thrombin (glycoform B) | 7.3 | 2.18 |
| α-thrombin (glycoform C) | 4.3 | 0.58 |
| AutA (glycoform A) | 8.3 | 4.79 |
| AutA (glycoform B) | 4.9 | 4.96 |
| AutA (glycoform C) | 15.6 | 8.70 |
| AutB′ | 0.8 | 2.78 |
| AutB | 7.8 | 1.29 |
| AutC | −6.0 | 1.95 |
| AutD (glycoform A) | 82.8 | 5.55 |
| AutD (glycoform B) | −40.2 | 15.77 |
| AutD (glycoform C) | 7.4 | 5.60 |

ppm—parts per million

TABLE 2
Quantitative Intra- and Inter-Assay Precision and Comparison
with Main Peak Purity Results by RP-HPLC
Quantitative Intra-Assay Precision: Average Percentage of α-thrombin and its Autolysis
Products in a Degraded rThrombin Sample Determined by LC-TOF Analysis (N = 6)

| Sample ID | α-thrombin | AutA | AutB′ | AutB | AutC | AutD |
|---|---|---|---|---|---|---|
| 060606-1 | 91.9 | 2.2 | 0.5 | 4.4 | 0.7 | 0.3 |
| | | 8.1 | | | | |
| 060606-2 | 92.4 | 2.2 | 0.4 | 3.8 | 0.7 | 0.5 |
| | | 7.6 | | | | |
| 060606-3 | 91.6 | 2.2 | 0.5 | 4.5 | 0.8 | 0.4 |
| | | 8.4 | | | | |
| 060606-4 | 91.6 | 2.1 | 0.5 | 4.5 | 0.8 | 0.4 |
| | | 8.4 | | | | |
| 060606-5 | 92.2 | 2.0 | 0.5 | 4.2 | 0.8 | 0.4 |
| | | 7.8 | | | | |
| 060606-6 | 91.9 | 2.0 | 0.5 | 4.4 | 0.8 | 0.4 |
| | | 8.1 | | | | |
| Average | 91.9 | 2.1 | 0.5 | 4.3 | 0.8 | 0.4 |
| Standard | 0.31 | 0.10 | 0.03 | 0.28 | 0.05 | 0.05 |
| Deviation | | | | | | |
| % RSD | 0.3 | 4.8 | 5.8 | 6.5 | 6.9 | 11.1 |

| | | | | | |
|---|---|---|---|---|---|
| α-thrombin | AutA | AutB′ | AutB | AutC | AutD |

Quantitative Inter-Assay Precision: Average Percentage of α-thrombin and its Autolysis
Products from the same Degraded rThrombin Sample Analyzed Four Times by LC-TOF
Analysis (N = 4*6)

| | | | | | | |
|---|---|---|---|---|---|---|
| Analysis 1 | 91.9 | 2.1 | 0.5 | 4.3 | 0.8 | 0.4 |
| Analysis 2 | 92.0 | 2.1 | 0.5 | 4.3 | 0.7 | 0.4 |
| Analysis 3 | 91.9 | 2.3 | 0.5 | 4.2 | 0.7 | 0.5 |
| Analysis 4 | 90.8 | 2.7 | 0.5 | 4.9 | 0.6 | 0.5 |
| Average | 91.7 | 2.3 | 0.5 | 4.4 | 0.7 | 0.5 |
| Standard | 0.48 | 0.24 | 0.02 | 0.27 | 0.07 | 0.03 |
| Deviation | | | | | | |
| % RSD | 0.5 | 10.5 | 4.1 | 6.2 | 10.4 | 7.6 |

Main Peak Purity of the Same Degraded rThrombin Sample Determined by RP-HPLC (N = 3)

| | | |
|---|---|---|
| Analysis 1 | 91.8 | 8.2 |

TABLE 3
HPLC Parameters

Column: PLRP-S 5 μm 300 Å 50 × 1.0 mm dedicated to this assay
Mobile Phase A: (90% H₂O, 10% ACN) 0.1% TFA (w/v)
Mobile Phase B: (90% ACN, 10% H₂O) 0.1% TFA (w/v)
Total Run-Time: 25.0 minutes
Column Temperature: 30° C.
Autosampler Temperature: 4° C.
Injector Draw Speed: 20 μL/min
Injector Eject Speed: 80 μL/min
Injector Mode: Injection with Needle Wash (for 1 s in Flush Port)

| | | | Flow Rate |
|---|---|---|---|
| Elution Gradient/Time Table: | Time [min] | % B | [μL/min] |
| | 0.00 | 29 | 20 |
| | 1.00 | 29 | 20 |
| | 8.5 | 35 | 20 |
| | 15.00 | 37 | 20 |
| | 18.00 | 90 | 20 |
| | 20.00 | 90 | 20 |
| | 21.00 | 29 | 20 |
| | 25.00 | 29 | 20 |

DAD Data Collection Wavelengths: Signal A - 215 nm (8 nm bandwidth),
Signal B - 280 nm (16 nm bandwidth)
DAD Reference Wavelengths: Signal A - 350 nm (100 nm bandwidth),
Signal B - 350 nm (60 nm bandwidth)
DAD Autobalance: Prerun mode
Peak Width Response Time: >0.05 min (1.0 s)
Slit Width: 4 nm
Margin for Negative Absorbance: 100 mAu
Minimal Injection Volume: 0.01 μL
Maximum Pressure with the Column in Line: 200 bar

TABLE 4
TOF Settings
Scan Segment 1, Time Segment 1 (Start 0.00 min):

| [General] | |
|---|---|
| Ion Polarity: | Positive |
| LC Stream Valve: | Waste |
| [Data] | |
| Storage Mode: | None |
| Transients/Scan: | 10000 |
| Min Range (m/z): | 100 |
| Max Range (m/z): | 2800 |
| Length of Transients: | 104992 |
| Bin Width (nsec): | 1.00 |
| Abs. Centroid Threshold (counts): | 5000 |
| Rel. Centroid Threshold (% counts): | 0.010 |
| [MS Parameters] | |
| Fragmentor (V): | 275 |
| Skimmer (V): | 75 |
| OCT RF V (V): | 300 |
| [Ion Source] | |
| Gas Temp (C.): | 350 |
| Drying Gas (l/min): | 8.0 |
| Nebulizer (psig): | 10 |
| Capillary (V): | 5000 |
| [Reference Masses] | |
| Enable Reference Mass Correction: | TRUE |
| Use Bottle A: | TRUE |
| Average (scans): | 11 |
| Detection Window (ppm): | 50 |
| Minimum Height (counts): | 100 |
| Mass list | 922.009798 |
| | 2421.913990 |
| | 322.048121 |

Scan Segment 1, Time Segment 2 (Start 3.50 min):

| | |
|---|---|
| [General] | |
| Ion Polarity: | Positive |
| LC Stream Valve: | MS |
| [Data] | |
| Storage Mode: | Profile |
| Transients/Scan: | 10000 |
| Min Range (m/z): | 100 |
| Max Range (m/z): | 2800 |
| Length of Transients: | 104992 |
| Bin Width (nsec): | 1.00 |
| Abs. Centroid Threshold (counts): | 5000 |
| Rel. Centroid Threshold (% counts): | 0.010 |
| [MS Parameters] | |
| Fragmentor (V): | 275 |
| Skimmer (V): | 75 |
| OCT RF V (V): | 300 |
| [Ion Source] | |
| Gas Temp (C.): | 350 |
| Drying Gas (l/min): | 8.0 |
| Nebulizer (psig): | 10 |
| Capillary (V): | 5000 |
| [Reference Masses] | |
| Enable Reference Mass Correction: | TRUE |
| Use Bottle A: | TRUE |
| Average (scans): | 11 |
| Detection Window (ppm): | 50 |
| Minimum Height (counts): | 100 |
| Mass list | 922.009798 |
| | 2421.913990 |
| | 322.048121 |

What is claimed:

1. A method for determining batch purity of a thrombin composition, comprising the steps of:
a. obtaining a batch of thrombin composition comprising α-thrombin molecule and autolysis products of said α-thrombin molecule;
b. providing a sample of said thrombin composition to a chromatographic compatible solvent to obtain a solution of said thrombin in solvent;
c. providing said solution to a gradient column and collecting fractions of solution;
d. providing said fractions to a mass spectrometer;
e. detecting a molecular mass of the fractions; and
f. quantifying the relative amount of α-thrombin molecule and relative amount of said autolysis products as a percentage of total thrombin composition.

2. The method of claim 1, wherein said thrombin is recombinant thrombin.

3. The method of claim 1, wherein said thrombin is plasma-derived thrombin.

4. The method of claim 3, wherein said plasma-derived thrombin is human plasma-derived thrombin or bovine plasma-derived thrombin.

5. The method of claim 2, wherein said recombinant thrombin composition comprises a recombinant α-thrombin molecule and autolysis products of said recombinant α-thrombin molecule; wherein, said sample is from about 0.5 μg to about 2.5 μg of said recombinant thrombin composition; wherein said chromatographic compatible solvent is an HPLC compatible solvent; and wherein, said solution is a solution of from about 0.2 mg/ml to about 0.5 mg/ml of said recombinant thrombin in said solvent.

6. The method of claim 1 wherein said autolysis products comprise an AutA species, an AutB species, an AutB′ species, an AutC species and an AutD species.

7. The method of claim 1 wherein said chromatographic compatible solvent is HPLC grade water.

8. The method of claim 1 wherein said gradient column is a PLRP-S column.

9. The method of claim 1 wherein said gradient column of step c is in contact with said mass spectrometer of step d such that said fractions of said solution will elute into said mass spectrometer.

10. The method of claim 1 wherein said mass spectrometer is an ESI-TOF mass spectrometer or a MALDI-TOF mass spectrometer.

11. The method of claim 1 wherein one or more reference ions are added to one or more of said fractions before step e, thereby providing an internal mass calibrant.

12. The method of claim 1 wherein at the step of detecting a molecular mass said molecular mass is detected with a mass to charge ratio of from about 900 to about 3250.

13. The method of claim 1 wherein at the step of detecting a molecular mass said molecular mass is detected with a mass range from about 7,000 Da to about 50000 Da.

14. The method of claim 5 wherein said recombinant α-thrombin molecule is quantified to make up from about 90.0% to about 93.0% of said recombinant thrombin composition.

15. The method of claim 5 wherein said autolysis product is quantified to make up from about 7.0% to about 10.0% of said recombinant thrombin product.

16. The method of claim 6 wherein said AutA species is from about 1.8% to about 3.0% as determined by LC-MS.

17. The method of claim 6 wherein said AutB species is from about 3.5% to about 5.3% as determined by LC-MS.

18. The method of claim 6 wherein said AutB′ species is from about 0.25% to about 0.75% as determined by LC-MS.

19. The method of claim 6 wherein said AutC species is from about 0.5% to about 1.1% as determined by LC-MS.

20. The method of claim 6 wherein said AutD species is from about 0.2% to about 0.65% as determined by LC-MS.

21. The method of claim 5 wherein said quantified amount of recombinant α-thrombin is compared to a standard acceptable range for quantity of recombinant α-thrombin in a batch.

22. The method of claim 5 wherein said quantified amount of said autolysis product is compared to a standard acceptable range for quantity of autolysis product in a batch.

23. The method of claim 6 wherein one or more of said autolysis product species is compared to a standard acceptable range for quantity of said one or more autolysis product species in a batch.

24. A method for determining lot-to-lot consistency of a thrombin composition, comprising the steps of:
a. obtaining a thrombin composition, wherein said thrombin composition comprises α-thrombin molecules and autolysis products of said α-thrombin molecules;
b. generating a solution of thrombin composition in an HPLC compatible solvent wherein said solution:
i. is from about 0.2 mg/ml to about 0.5 mg/ml of said thrombin composition in HPLC compatible solvent;
ii. totals from about 0.5 μg to about 2.5 μg of said thrombin composition;
c. providing said solution generated in step b to a gradient column and collecting a set of fractions for said solution;
d. providing said fractions to a mass spectrometer to generate a molecular mass profile;
e. detecting a molecular mass of the fractions, thereby generating a molecular mass profile for said solution;
f. quantifying the relative amount of α-thrombin molecules and relative amount of said autolysis products as a percentage of total thrombin composition for said thrombin composition; and
g. comparing said quantified amount of α-thrombin molecules and/or said quantified amount of said autolysis products to a reference thereby determining lot-to-lot consistency for said thrombin composition.

25. The method of claim 24, wherein said thrombin is recombinant thrombin.

26. The method of claim 24, wherein said thrombin is plasma-derived thrombin.

27. The method of claim 26, wherein said plasma-derived thrombin is human plasma-derived thrombin or bovine plasma-derived thrombin.

28. The method of claim 24 wherein said autolysis products comprise an AutA species, an AutB species, an AutB′ species, an AutC species and an AutD species.

29. The method of claim 24 wherein said HPLC compatible solvent is HPLC grade water.

30. The method of claim 24 wherein said gradient column is a PLRP-S column.

31. The method of claim 24 wherein said gradient column of step c is in contact with said mass spectrometer of step d such that said fractions of said solution will elute into said mass spectrometer.

32. The method of claim 24 wherein said mass spectrometer is an ESI-TOF mass spectrometer or a MALDI-TOF mass spectrometer.

33. The method of claim 24 wherein one or more reference ions are added to one or more of said fractions before step e, thereby providing an internal mass calibrant.

34. The method of claim 24 wherein at the step of detecting a molecular mass said molecular mass is detected with a mass to charge ratio of from about 900 to about 3250.

35. The method of claim 24 wherein at the step of detecting a molecular mass said molecular mass is detected with a mass range from about 7,000 Da to about 50000 Da.

36. The method of claim 24 wherein said α-thrombin molecule is quantified to make up from about 90.0% to about 93.0% of said thrombin composition.

37. The method of claim 24 wherein said autolysis product is quantified to make up from about 7.0% to about 10.0% of said thrombin product.

38. The method of claim 28 wherein said AutA species is from about 1.8% to about 3.0% as determined by LC-MS.

39. The method of claim 28 wherein said AutB species is from about 3.5% to about 5.3% as determined by LC-MS.

40. The method of claim 28 wherein said AutB′ species is from about 0.25% to about 0.75% as determined by LC-MS.

41. The method of claim 28 wherein said AutC species is from about 0.5% to about 1.1% as determined by LC-MS.

42. The method of claim 28 wherein said AutD species is from about 0.2% to about 0.65% as determined by LC-MS.

43. The method of claim 24 wherein said reference is a second batch of thrombin composition.

44. The method of claim 24 wherein a plurality of batches of thrombin compositions are separately quantified and the quantification results for each of said plurality of batches serves as a reference for comparison of one to another thereby determining lot-to-lot consistency between said plurality of batches.

45. The method of claim 24 wherein said reference is an external standard.
